(19) United States
(12) Patent Application Publication
(10) Pub. No.: US 2026/0356455 A1
(43) Pub. Date: Nov. 12, 2026

(54) Method for Controlling a Vehicle

(71) Applicant: Robert Bosch GmbH, Stuttgart (DE)

(72) Inventors: Jo Pletinckx, Sersheim (DE); Markus Hanselmann, Stuttgart (DE); Holger Ulmer, Ulm (DE)

(21) Appl. No.: 19/130,836

(22) PCT Filed: Nov. 9, 2023
(86) PCT No.: PCT/EP2023/081283

§ 371 Date: May 16, 2025

(30) Foreign Application Priority Data
Nov. 18, 2022 (DE) 10 2022 212 296.8

(51) Int. Cl. B62M 6/50; B62J 45/412; B62J 45/413; B62J 45/414; G01P 3/50

(52) U.S. Cl. CPC B62M 6/50; B62J 45/412; B62J 45/413; B62J 45/414; G01P 3/50

(57) ABSTRACT

A method for controlling a vehicle, in particular a single-track vehicle such as an electric bike, includes (i) measuring a speed of the vehicle at a plurality of points in time using the speed sensor, (ii) measuring accelerations and/or rotational rates of the vehicle in at least one direction, preferably in three directions, at the plurality of points in time, (iii) determining, by way a machine learning model, a speed and/or a speed change of the vehicle based on the measured accelerations and/or rotational rates at the plurality of points in time, and (iv) controlling the vehicle based on a comparison of the measured speeds and the determined speeds and/or determined speed change at the plurality of points in time.

The invention relates to a method for controlling a vehicle, in particular a single-track vehicle such as an electric bike.

The invention further relates to a vehicle, in particular a single-track vehicle such as an electric bike, having a speed sensor.

Although generally applicable to vehicles, the following invention is explained with reference to electric bikes.

### PRIOR ART

To determine the speed of electric bikes, it has become known to place a magnet on the rear wheel of the electric bike. By means of a magnetic field sensor (a so-called reed sensor), the rotation passes of the magnet can be detected and, based on the temporal interval between two detected magnetic signals, the speed of the electric bike can be determined. It is also contemplated that the strength of a magnetic field is measured by means of a magnetic field sensor, rather than a reed sensor, which is only triggered at a predetermined magnetic field strength. Based on the curve of the measured magnetic field strength, the speed can then be determined.

It is possible that the electric bike is intended to provide a torque support only at a certain speed. Thus, an accurate speed measurement is necessary in order to prevent a torque support beyond the desired speed. The speed sensor may be faulty due to sensor defects.

### DISCLOSURE OF THE INVENTION

In one embodiment, the present invention provides a method for controlling a vehicle, in particular a single-track vehicle such as an electric bike, comprising the steps of:
measuring a speed of the vehicle at a plurality of points in time using a speed sensor,
measuring accelerations and/or rotational rates of the vehicle in at least one direction, preferably in three directions, at the plurality of points in time,
determining, by way a machine learning model, a speed and/or a speed change of the vehicle based on the measured accelerations and/or rotational rates at the plurality of points in time, and
controlling the vehicle based on a comparison of the measured speeds and the determined speeds and/or determined speed change at the plurality of points in time.

In one embodiment, the present invention provides a vehicle, in particular a single-track vehicle, such as an electric bike, having a speed sensor, as well as:
a first measurement unit configured so as to measure a speed of the vehicle at a plurality of points in time using the speed sensor,
a second measurement unit configured so as to measure accelerations and/or rotational rates of the vehicle in at least one direction, preferably in three directions, at the plurality of points in time,
a determination unit configured so as to determine, by way of a machine learning model, a speed and/or a change in speed of the vehicle based on the measured accelerations and/or rotational rates at the plurality of points in time, and
a control unit configured so as to control the vehicle by comparing the measured speeds and the determined speeds and/or determined speed change at the plurality of points in time.

One of the advantages achieved thereby is that the speed of the vehicle can be determined in two different ways. When the speed signals are different, this can be an indicator that the speed sensor is faulty. A further advantage is that the identification of a sensor error is enabled in a simple and inexpensive manner, so that the vehicle can be controlled based on it.

The phrase “comparing the measured speeds and determined speeds and/or determined speed change” is to be understood in the broadest sense and relates, in particular in the specification, preferably in the claims, to a mathematical and/or statistical operation in which the measured and determined speeds and/or determined speed changes are linked together. For example, this can be done using a mathematical comparison (the determined speed is greater than the measured speed) or by comparing the curves of the determined and measured speeds. It is also possible to determine a cumulative deviation of the measured and determined speeds over a plurality of time points and compare it to a threshold value.

The term “sensor error” is to be understood in the broadest sense and refers, in particular in the specification and preferably in the claims, to faulty measurement signals of the sensor and/or manipulated signals of the sensor, among other things.

The machine learning model can be configured so as to determine the speed based on a regression and/or a classification. In the regression, the method is configured so as to determine an output value, wherein the output value is calculated by the machine learning model using a regression.

The machine learning model can be configured as a trained machine learning system or as a machine learning system that is yet to be trained. In one embodiment, the trained machine learning model is not adapted during execution. The machine learning model can be executed locally, for example by an electronics of the electric bike and/or a mobile device, and/or remotely, for example on a web server or in the cloud.

In one embodiment, the machine learning model has a signal input through which the input values for the classification are provided partially or fully. The provision can be made, for example, by the electric bike, in particular by a sensor unit of the electric bike, and/or the mobile device, such as a smartphone.

The term “regression” is intended in particular to mean that a starting value is determined, wherein the starting value can be configured as a physical value or as a curve of a physical value. The output value can be configured as a physical value, which can or can be also provided by a further machine learning model, or a sensor unit of the electric bike, or the mobile terminal. The output value can also be configured as a virtual output value derived from the input values, or its curve. The output value can subsequently be used in order to assign a class and/or to control a method, for example to control the electric bike.

The determined output value is preferably linked to a confidence, wherein the confidence is to be considered a measure that reflects a proximity of the input values from the training data through which the machine learning model has been trained. If, for example, the machine learning model was trained with training data that is very far away from the input values, the confidence would be low.

For example, the machine learning system can be configured as an SVM (support vector machines) algorithm, as at least one decision tree, in particular as a “random forest” method, as a Bayesian network, or as a neural network, in particular as an MLP (multilayer perceptron).

The machine learning system can also be configured as a deep learning neural network, for example, a recurrent neural network (RNN), in particular an LSTM (long short term memory) network or GRU (gated recurrent units) network, a CNN (convolutional neural network), a TCN (temporal convolutional network), or as a combination of the aforementioned networks.

Further features, advantages, and other embodiments of the invention are described in the following or are thereby disclosed.

According to an advantageous further development of the invention, the machine learning model is trained based on data based on an error-free trip of a vehicle. In particular, the machine learning model can be trained solely based on this data. With the embodiments of the invention, a faulty sensor can be identified. Because a possible error does not need to be classified, the training data can be based solely on an error-free trip. The machine learning model consequently identifies faulty sensors due to the fact that input data differs from the training data, which defines the error-free state. Thus, previously unknown errors can also be detected by the machine learning model, because it is not trained to find specific errors, but rather only to determine a difference compared to error-free data. In this way, unknown errors can be detected, and sensor errors can be identified easily. In particular, the machine learning model can be trained “offline,” that is to say, outside the vehicle itself, because possible errors do not need to be included in the data.

According to an advantageous further development of the invention, a sensor error is identified when a specifiable deviation between the measured and determined speeds is detected over a period of at least 1 second, preferably at least 5 seconds, in particular at least 10 seconds. When the deviation is detected only for a short period of time, this indicates that the sensor is not faulty. One advantage of this is that the likelihood of false-positive sensor errors is reduced.

According to an advantageous further development of the invention, to control the vehicle, a value for the deviation is determined based on the determined speeds and/or determined speed changes and the measured speeds, wherein the value of the deviation is compared to a threshold value of the deviation, and wherein the threshold value is based on a detection rate, a maximum false-positive rate, and/or a time period in which the measurements are taken. The deviation value is a measure of the difference between the measured speeds and determined speeds and/or determined speed changes. The value of the deviation is thus a direct measure of whether a sensor error exists. This value can be determined, for example, using the mean square error. It is also conceivable that the deviation threshold depends on additional parameters, such as a desired detection rate of sensor errors, a desired false-positive rate of sensor errors, and/or a specific time period in which the differences are measured. It is also conceivable that the deviation value itself depends on the additional parameters. One advantage of this is that the threshold of the deviation can be used as a direct measure of sensor errors. A further advantage is that the threshold deviation is adjustable; for example, a low deviation value could already indicate a sensor error when a high detection rate is desired, or a high deviation value might be required when a low false-positive rate is desired.

According to an advantageous further development of the invention, the machine learning model is provided in the form of a recurrent neural network, in particular in combination with a 1D convolution. Using the 1D convolution, patterns from a time course of the rotation rate and/or acceleration signals and/or relationships between different signals such as acceleration and rotation rate can be detected. One advantage of this is that a machine learning model can be easily created and trained.

According to an advantageous further development of the invention, in the machine learning model, the determination of the speed and/or the speed change is based on a cadence, a driver torque, a drive unit speed, a drive torque, and/or a drive power. Parameters describing the current driving state of the vehicle can be used as possible input values of the machine learning model. Based on these values, the speed or the speed change can be determined. One advantage of this is that the speed can be determined more precisely.

According to an advantageous further development of the invention, to control the vehicle, a classification of the determined speed is determined based on the machine learning model, in particular a classification into certain speed intervals (ordinal classification), wherein the classification of the determined speed is compared to the measured speed. In this case, the machine learning model does not directly determine the speed, but rather only an interval in which the speed lies. Thus, a classification of the speed can be made, for example “low, medium, high.” It is also contemplated that this classification can be compared to the measured speed and/or to a classified measured speed in order to detect a sensor error. In other words, the machine learning model can be designed so as to determine the speed based on an ordinal classification. The machine learning model does not determine a discrete value for the determined speed, but rather always determines a preferably specifiable range of values.

According to an advantageous further development of the invention, the determination of the speed is performed by way of the machine learning model based on a regression, in particular wherein the speed determined by regression is configured as a discrete speed value. One advantage of this is that the speed can be determined more precisely. In particular, the regression can determine a discrete speed value, for example 25 km/h, as opposed to an ordinal or qualitative classification.

According to an advantageous further development of the invention, the machine learning model determines the speed based on a classification. The speed determined based on the classification can be configured as a speed value or as a numerical or qualitative speed range, for example “20 to 25 km/h” or “high speed.” One advantage of this is that the speed can be determined efficiently.

According to an advantageous further development of the invention, the speed sensor is configured as a pulse-based speed sensor, in particular a reed sensor. One advantage of this is that the speed sensor can be implemented inexpensively.

Further important features and advantages of the invention arise from the dependent claims, from the drawings and from the associated description of the figures.

It goes without saying that the aforementioned features and the features yet to be explained in the following can be used not only in the respectively specified combination, but also in other combinations or on their own, without leaving the scope of the present invention.

Preferred designs and embodiments of the present invention are shown in the drawings and are explained in more detail in the following description.

Shown in schematic form are:

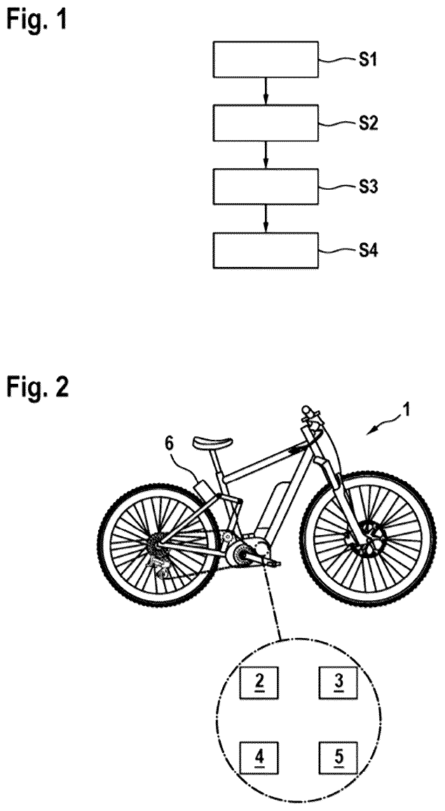

FIG. 1 steps of a method according to one embodiment of the present invention;

FIG. 2 a vehicle according to one embodiment of the present invention.

FIG. 1 schematically shows steps of a method according to an embodiment of the present invention.

In step S1, the speed of a vehicle is measured at a plurality of points in time using a speed sensor, in particular a pulse-based one. For example, the pulse-based speed sensor can be a reed sensor.

In a further step S2, accelerations and/or rotational rates of the vehicle in at least one direction, preferably in three directions, are measured at the plurality of points in time. In particular, the accelerations and rotational rates are measured in the travel, transverse, and vertical directions.

In a further step S3, a speed and/or a change in speed of the vehicle is determined by way of a machine learning model based on the measured accelerations and/or rotational rates at the plurality of points in time. Additionally, further parameters such as a drive line or a driver's cadence can be used in order to determine the speed. For example, the machine learning model can be a neural network that has accelerations and rotational rates in various directions as input values and speed as output values. The speed can be determined at a plurality of points in time. The neural network has been trained with data from error-free sensors during a trip. The machine learning model can thus determine the speed that the vehicle currently has. When the measured speed deviates from the determined speed, this indicates that the speed sensor is faulty. Because speed is determined using a machine learning model, influences such as sensor drift or inaccurate sensors can be detected and/or compensated.

In step S4, the vehicle is controlled based on a comparison of the measured speeds and the determined speeds and/or determined speed changes at the plurality of points in time. Specifically, the vehicle is controlled based on a detection of a sensor error in the speed sensor. The measured and determined speeds can be compared, and, based on this, a value of a deviation between the two speeds can be calculated, which can be compared to a threshold value of the deviation, for example. It is also contemplated that a change in speed will be determined and compared to the measured speed difference, in particular the difference between two speeds measured at subsequent points in time. The threshold value of the deviation can additionally be based on other parameters, for example, a desired maximum false-positive rate.

The value of the deviation is a measure of the probability that the sensor is faulty. For example, a threshold value can be defined, and when the value of the deviation is greater than the threshold value, the sensor is identified as defective. In addition, the value of the deviation could represent the probability that the sensor is faulty. It is also contemplated that the value of the deviation is a binary value that classifies the sensor as defective or operational. In particular, the value of the deviation can be based on measured and determined speeds at a plurality of points in time so that longer-term deviations can also be detected. The longer the determined and measured speeds differ from one another, the greater the likelihood that the sensor is faulty. The vehicle can be controlled accordingly. For example, a drive support of the vehicle can be controlled based on the determined speed rather than the measured speed when the speed sensor is anticipated to be faulty.

It is also contemplated that the speed is determined qualitatively rather than quantitatively, i.e. it is determined whether the vehicle is in a particular speed interval. The determined speed interval can in turn be compared to the measured speed and the value of the deviation can be determined therefrom.

The machine learning model determines the speed of the vehicle and compares the determined speed to the measured speed. Thus, only the existence of faulty sensors is determined, but not the type of error. Therefore, not only known errors of the sensors can be determined, but also unknown errors.

FIG. 2 shows in schematic form a vehicle according to one embodiment of the present invention.

The vehicle 1, here in the form of an electric bike, comprises a speed sensor 6, here in the form of a pulse-based sensor, i.e. a reed sensor. Furthermore, the vehicle comprises 1:
a first measurement unit 2 configured so as to measure the speed of the vehicle at a plurality of points in time using the speed sensor,
a second measurement unit 3 configured so as to measure accelerations and/or rotational rates of the vehicle in at least one direction, preferably in three directions, at the plurality of points in time,
a determination unit 4 configured so as to determine, by way of a machine learning model, the speed and/or the speed change of the vehicle based on the measured accelerations and/or rotational rates at the plurality of points in time, and
a control unit 5 configured so as to control the vehicle 1 by comparing the measured speeds and the determined speeds and/or determined speed change at the plurality of points in time.

In particular, the vehicle 1 is configured so as to perform the steps S1 through S4 as shown in FIG. 1. The first measurement unit 2 can be formed integrally with the speed sensor 6.

Although the present invention has been described with reference to preferred exemplary embodiments, it is not limited to these and can be modified in a variety of ways.

1. A method for controlling a vehicle, comprising:
measuring a speed of the vehicle at a plurality of points in time using a speed sensor,
measuring accelerations and/or rotational rates of the vehicle in at least one direction, at the plurality of points in time,
determining, by way of a machine learning model, a speed and/or a speed change of the vehicle based on the measured accelerations and/or rotational rates at the plurality of points in time, and
controlling the vehicle based on a comparison of the measured speeds and the determined speeds and/or determined speed change at the plurality of points in time.

2. The method according to claim 1, wherein the machine learning model is trained based on data based on an error-free trip of a vehicle.

3. The method according to claim 1, wherein a sensor error is identified when a specifiable deviation between measured and determined speeds is detected over a period of at least 1 second.

4. The method according to claim 1, wherein, to control the vehicle, a value for the deviation is determined based on the determined speeds and/or determined speed changes and the measured speeds, and wherein the value of the deviation is compared to a threshold value of the deviation, wherein the threshold value is based on a detection rate, a maximum false-positive rate, and/or a time period in which the measurements are taken.

5. The method according to claim 1, wherein the machine learning model is provided in the form of a recurrent neural network in combination with a 1D convolution.

6. The method according to claim 1, wherein, in the machine learning model, the determination of the speed and/or the speed change is based on a cadence, a driver torque, a drive unit speed, a drive torque, and/or a drive power.

7. The method according to claim 1, wherein the determination of the speed is performed by way of the machine learning model based on a regression, wherein the speed determined by regression is configured as a speed value.

8. The method according to claim 1, wherein the determination of the speed is performed by the machine learning model based on a classification.

9. The method according to claim 1, wherein the speed sensor is formed as a pulse-based speed sensor.

10. A vehicle having a speed sensor, and:
a first measurement unit configured so as to measure a speed of the vehicle at a plurality of points in time using the speed sensor,
a second measurement unit configured so as to measure accelerations and/or rotational rates of the vehicle in at least one direction at the plurality of points in time,
a determination unit configured so as to determine, by way of a machine learning model, a speed and/or a change in speed of the vehicle based on the measured accelerations and/or rotational rates at the plurality of points in time, and
a control unit configured so as to control the vehicle by comparing the measured speeds and the determined speeds and/or determined speed change at the plurality of points in time.

11. The method according to claim 1, wherein the vehicle is a single-track vehicle.

12. The method according to claim 11, wherein the single-track vehicle is an electric bike.

13. The method according to claim 1, wherein measuring accelerations and/or rotational rates of the vehicle in at least one direction includes measuring accelerations and/or rotational rates of the vehicle in three directions at the plurality of points in time.

14. The method according to claim 1, wherein a sensor error is identified when a specifiable deviation between measured and determined speeds is detected over a period of at least 5 seconds.

15. The method according to claim 1, wherein a sensor error is identified when a specifiable deviation between measured and determined speeds is detected over a period of at least 10 seconds.

16. The method according to claim 1, wherein the speed sensor is formed as a reed sensor.

17. The vehicle according to claim 10, wherein the vehicle is a single-track vehicle.

18. The vehicle according to claim 17, wherein the single-track vehicle is an electric bike.

19. The vehicle according to claim 10, wherein the second measurement unit is configured so as to measure accelerations and/or rotational rates of the vehicle in three directions at the plurality of points in time.
